(19) United States
(12) Patent Application Publication
(10) Pub. No.: US 2016/0105486 A1
(43) Pub. Date: Apr. 14, 2016

(54) SOCIAL MEDIA SHARING SYSTEM AND METHOD THEREOF

(71) Applicants: INVENTEC APPLIANCES (PUDONG) CORPORATION, Shanghai (CN); INVENTEC APPLIANCES CORP., New Taipei City (TW)

(72) Inventor: Lin-Chia Lee, New Taipei City (TW)

(21) Appl. No.: 14/661,611

(22) Filed: Mar. 18, 2015

(30) Foreign Application Priority Data
Oct. 13, 2014 (CN) 201410537851.X

(51) Int. Cl. H04L 29/08; G06F 17/30

(52) U.S. Cl. CPC H04L 67/06; G06F 17/30864

(57) ABSTRACT

The present invention discloses a social media sharing system including a mobile device, a media playing device, a social networking website, a cloud database and a media resource platform. The members in the social networking website can together edit a media list and then store the media list in the cloud database. The media playing device of the present invention analyzes the content of the media list and obtains a media website address from the media resource platform so as to share the social media instantly.

### FIELD OF THE INVENTION

The present invention relates to a field of information system, and particularly relates to a social media sharing system and method thereof.

### BACKGROUND OF THE INVENTION

There are currently a variety of online media platforms, which not only contain common online media player but also combine social networking website. Users can also share the media by releasing a message to the social networking website while playing the media. Following platforms are some examples:

Spotify: It can be linked to Facebook, Tumblr or Twitter, and its functionality is sharing personal music information to the social networking website.

MixerBox: It can search, play or subscribe YouTube MV which Facebook friends are favorite. The version, iOS, supports sharing a single song link to Google Gmail, Facebook, WhatsApp or Twitter.

KKBOX: a self-development music society, myBOX, integrated with Facebook can instantly share music with relatives and friends or retrieve music.

Douban FM: Music can be shared to Facebook, Gmail, Google+, Weibo, or Douban's society service (Douban broadcast).

On the other hand, the existing social networking website provides functions which are allowed users with common interests to group a society and the members of the society can participate in the dialogue, share album, or start activities. Among them, Facebook provides a function of collaborative editing file. The society members can use this function to co-edit a file and the co-edited file will be represented in a different version number.

Although the aforementioned online media platforms classify the music classified by some themes such as singer, style, popularity, etc., users must record their own interested songs so as to edit the playlist. In addition, the recommended media website address (URL; Uniform Resource Locator) acquired by users of social networking website will not be integrated immediately into their playlist. Moreover, the media shared to the social networking websites through online media platforms is only post in the personal pages, not effectively recommended to friends with common preferences. In addition, the existing online media platforms can't co-edit a media list by a plurality of members in the society so as to share the media.

### SUMMARY OF THE INVENTION

According to the aforementioned problems, a social media sharing system and method thereof is provided in the present invention. The media playing device analyzes the co-edited documents of the society members. Searching is used to obtain the media website address to perform society media sharing. The users with common media preference utilize the society function of the social networking website to edit the media list together so that each of the members can share an interested media list and get rid of the trouble which the members have to pre-edit the content of the media list. In addition, the recommend media from the society members can be arranged efficiently in the media list. According to the media list, the media playing device is used to search and obtain the media website address from the online media platform and plays the media instantly.

According the object above, the present invention provides a social media sharing system, comprising: a social networking website including a logged-in society wherein the society provides a media list edited by a plurality of members in the society together; a media resource platform including a media website resources; a computing device with a media player program connected to the social networking website by a first communication link and configured to download the media list from the social networking website; a cloud database connected to the computing device by a second communication link and configured to receive the media list from the computing device; and a media playing device including a transmission unit, a microcontroller, a memory, and a playing unit, communicated to the computing devices, the cloud database and the media resource platform, wherein the transmission unit, the microcontroller and the memory are electrically connected to each other by a bus, the microcontroller is electrically connected to the playing unit by an output interface, and the memory contains a social media sharing program; wherein the media playing device acquires a media list from the cloud database, the social media sharing program analyzes the media list to get a media information and the social media sharing program searches in the media resource platform according to the media information to obtain a media website address corresponding to the media information from the media website resource, and the microcontroller based on the media website address controls the playing unit to play media.

In one preferred embodiment of the present invention, the media playing device in the aforementioned social media sharing system can play audio or video.

In one preferred embodiment of the present invention, the computing device in the aforementioned social media sharing system is a mobile device or a computer.

According to the object above, the present invention provides another social media sharing systems, comprising: a social networking website including a logged-in society login, wherein the society provides a media list edited by a plurality of members in the society together; a media resource platform including a media website resources; a computing device with a social media sharing program, connected to the social networking website by a first communication link and configured to download the media list from the social networking website; and a media playing device, communicated to the computing device; wherein the social media sharing program analyzes the media list to get a media information and the social media sharing program searches in the media resource platform according to the media information to obtain a media website address corresponding to the media information from the media website resource, and the social media sharing program based on the media website address controls the media playing device to play media.

In one preferred embodiment of the present invention, the media playing device in the aforementioned social media sharing system can play audio or video.

According to the object above, the present invention provides a social media sharing method implemented by a social media sharing system comprising a computing device, a social networking website, a media resource platform, a cloud database, and a media playing device, comprising steps of: establishing a media list, which can be co-edited, through the social networking website; analyzing the media list to obtain a media information through a social media sharing program; searching and obtaining a media website address based on the media information through the social media sharing program; and playing media loaded from the media website address through the media playing device.

In one preferred embodiment of the present invention, in the aforementioned media sharing method, the step of establishing the media list, which can be co-edited, through the social networking website further comprises: establishing a society in the social networking website, and a plurality of members in the society editing the media list together.

In one preferred embodiment of the present invention, in the aforementioned media sharing method, the step after the step of establishing the media list, which can be co-edited, through the social networking website further comprises: backing up the media list.

In one preferred embodiment of the present invention, in the aforementioned media sharing method, the media list is backed up in a cloud database.

In one preferred embodiment of the present invention, in the aforementioned media sharing method, the step after the step of establishing the media list, which can be co-edited, through the social networking website further comprises: comparing the media list with a cloud database to get a latest version.

In one preferred embodiment of the present invention, in the aforementioned media sharing method, the step of searching and obtaining the media website address based on the media information through the social media sharing program further comprises: utilizing media name, media author, media owner or media link in the media information to search.

### DESCRIPTION OF THE DRAWINGS

FIG. 1 is a block diagram illustrating the social media sharing system in one embodiment of the present invention;

FIG. 2 is a block diagram illustrating the social media sharing system in another embodiment of the present invention; and

FIG. 3 is a flowchart illustrating the social media sharing method in the present invention.

### DETAILED DESCRIPTION OF THE PREFERRED EMBODIMENTS

In the following detailed description of the preferred embodiments, reference is made to the accompanying drawings which form a part hereof, and as shown by way of illustration specific embodiments in which the invention may be practiced. In this regard, directional terminology, such as “top,” “bottom,” “front,” “back,” “left,” “right,” “inside,” “outside,” “side,” etc., is used with reference to the orientation of the FIG.(s) being described. As such, the directional terminology is used for purposes of illustration and is in no way limiting the present invention.

The present invention relates to a system and method for social media sharing. The present invention proposes a social media sharing method to play media loaded from the social media list of the social networking website. The algorithms, the database type, communication protocol or mechanical structure are not key points in the present invention and the description thereof is omitted.

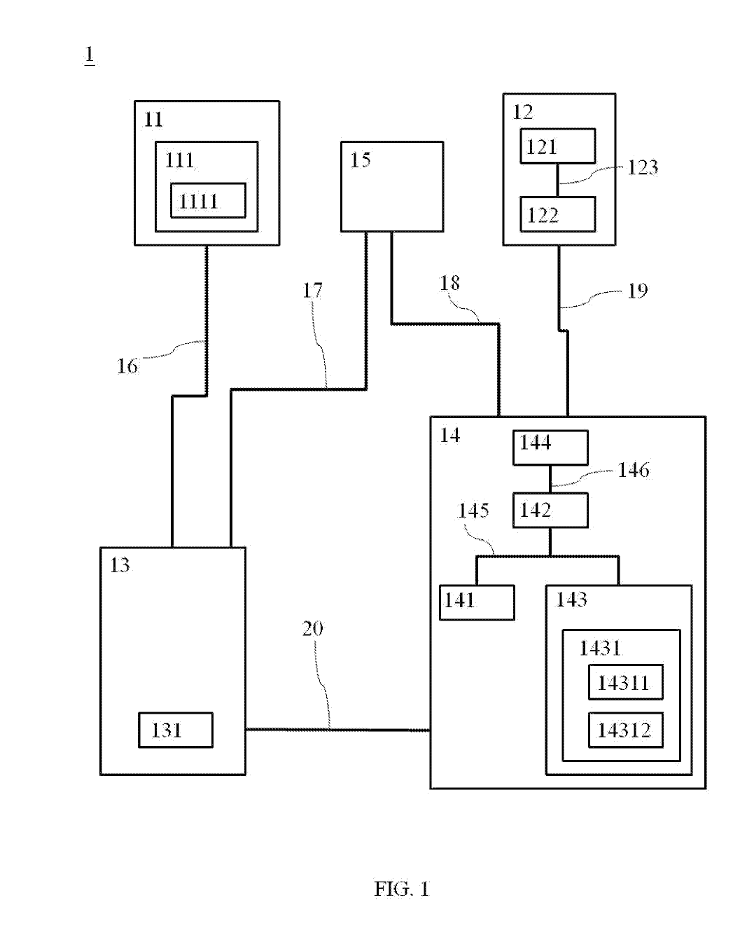

Please refer to FIG. 1, and FIG. 1 is a block diagram illustrating the social media sharing system in one embodiment of the present invention. As shown in FIG. 1, the social media sharing system in the present invention includes a computing device 13, a social networking website 11, a media resource platform 12, a cloud database 15, and a media playing device 14.

The social networking website 11 includes a logged-in society 111 which provides a media list 1111, and the media lists 1111 can be edited by a plurality of members in the society 111 together to perfect the contents. In other words, after the media list 1111 is generated, each of the members in the society 111 can modify the media list 1111, which is a common edit manner.

The media resources platform 12 includes a media website resource 121 and a query interface 122. The query interface 122 is connected to the media website resource 121 via the data link 123 to transmit the user's query or receive the media website address from searching.

The computing device 13 and the society networking website 11 are connected via the first communication link 16 to perform the social networking website 11 login, the events in the society networking website 11 and data transmission, such as uploading/updating or downloading the media list 1111. In addition, the computing device 13 and the cloud database 15 are connected via a second communication link 17 to perform data transmission, such as uploading/updating or downloading the media list 1111. In addition, the computing device 13 includes a media player program 131 and the media player program 131 is connected to media playing device 14 via the fifth communication link 20 to control the playback. The computing device 13 can be a mobile device or PC (Personal Computer) and so on.

The media playing device 14 includes a transmitting unit 141, a microcontroller 142, a memory 143, and a playing unit 144. The transmission unit 141, the microcontroller 142 and the memory 143 are electrically connected via a bus 145. The microcontroller 142 and the playing unit 144 are connected electrically via an output interface 146. The memory 143 includes a social media sharing program 1431, and the social media sharing program 1431 contains an analyzing function 14311 and an querying function 14312. In addition, when the media playing program 131 controls the media playing device 14, the media playing device 14 is connected to the cloud database 15 by the third communication link 18 to obtain the media list 1111, which is uploaded to the cloud database 15 by the computing device 13. In addition, the analyzing function 14311 analyzes the media list 1111 to acquire the media information (such as media name, media author, media owner or media link, etc.) The querying function 14312 is connected to the media resource platform 12 by the fourth communication link 19. According to the form of the query interface 122 in the media resource platform 12, the querying function 14312 is set to the search strategy corresponding to the media resource. When searching is processed by the query interface 122, the media website address corresponding to the media information is acquired from the media website resource 121 via the data link 123. In accordance with the media website address, the social media sharing program 1431 controls the playing unit 144 to play audio or video through the output interface 146 of the microcontroller 142.

The computing device 13 is connected to the media playing device 14 via the fifth communication link 20 to control the media player program 131. The members in the society can use the computing device 13 to pre-set the media playing device 14. When the media playing device 14 is turned on, the updated version of the media list 1111 is acquired from the cloud database 15. Then the media playing device 14 is connected to the media resource platform 12 to obtain the media website address and plays the media so as to achieve the social media sharing.

The transmission unit 141 of the media playing device 14 controls the third communication link 18, the fourth communication link 19 or the fifth communication link 20. The first communication link 16, the second communications link 17, the third communication link 18, the fourth communication link 19 and the fifth communication link 20 can be wired communication or wireless communication. The wireless communication satisfies the communication protocols, such as Bluetooth, Bluetooth Low Energy (BLE), Wireless Fidelity (Wi-Fi, Third Generation mobile communication (3G) or Fourth Generation mobile communications (4G) and so on. Wired communication satisfies the communication protocols, such as Open System Interconnection Reference Model (OSI), Transmission Control Protocol/Internet Protocol (TCP/IP), Point-to-Point (PPP) Protocol, PPP over Ethernet (PPPoE), Cable modem, Local Area Network (LAN), Wide Area Network (WAN), World Wide Web (WWW), NetWare, IPX/SPX, NetBEUI, Apple Talk, Asymmetric Digital Subscriber Line (ADSL), Public Switched Telephone Network (PSTN), Integrated Services Digital Network (ISDN) or Asynchronous Transfer Mode (ATM) and so on.

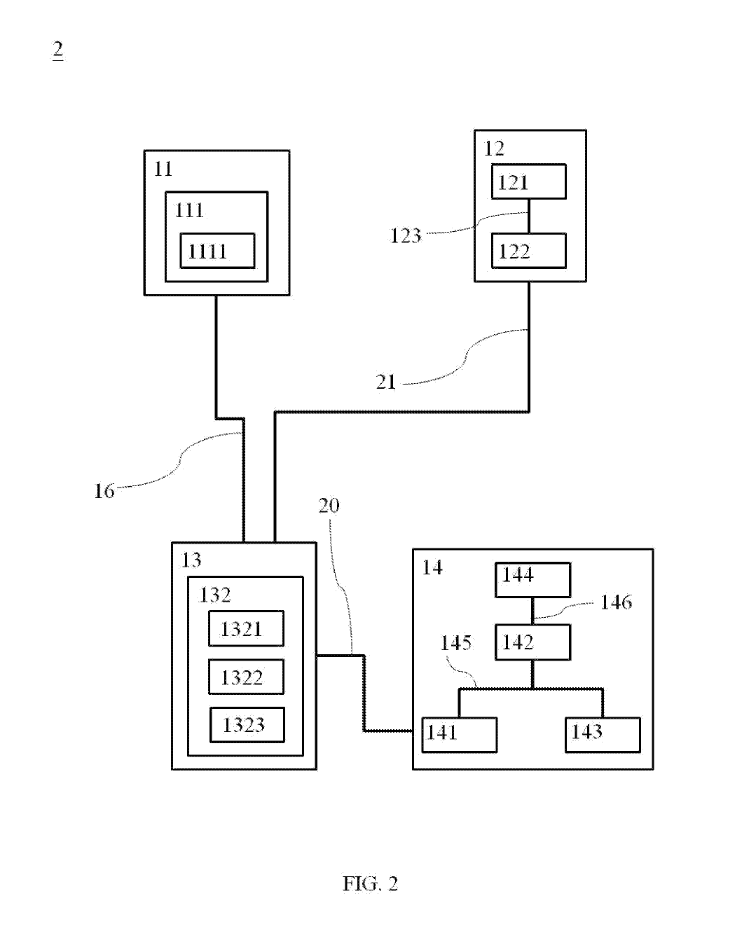

Next, please continue to see FIG. 2, and FIG. 2 is a block diagram illustrating the social media sharing system in another embodiment of the invention. As shown in FIG. 2, the social media sharing system in another embodiment of the present invention includes a computing device 13, a social networking website 11, a media resource platform 12 and a media playing device 14.

The social networking website 11 includes a logged-in society 111 which provides a media list 1111, and the media lists 1111 can be edited by a plurality of members in the society 111 together to perfect the contents. In other words, after the media list 1111 is generated, each of the members in the society 111 can modify the media list 1111, which is a common edit manner.

The media resources platform 12 (as the aforementioned online media platforms) includes a media website resource 121 and a query interface 122. The query interface 122 is connected to the media website resource 121 via the data link 123 to transmit the user's query or receive the media website address form searching.

The computing device 13 and the society networking website 11 are connected via the first communication link 16 to perform the social networking website 11 login, the events in the society networking website 11 and data transmission, such as uploading/updating or downloading the media list 1111. In addition, the computing device 13 includes a social media sharing program 132 connected to the media playing device 14 via the fifth communication link 20 to control the media playing device 14 and transmit data. The social media sharing program 132 includes an analyzing function 1321, a querying function 1322 and a media playing function 1323. The analyzing function 1321 analyzes the media list 1111 to acquire the media information (such as media name, media author, media owner or media link). The querying function 1322 is connected to the media resource platform 12 via the sixth communication link 21. According to the form of the query interface 122 in the media resource platform 12, the querying function 1322 is set to the search strategy corresponding to the media resource. When searching is processed by the query interface 122, the media website address corresponding to the media information is acquired from the media website resource 121 via the data link 123. In accordance with the media website address, the media playing function 1323 controls the microcontroller 142 of the media playing device 14 via the fifth communication link and the microcontroller 142 further controls the playing unit 144 to play audio or video via the output interface 146. The computing device 13 can be a mobile device, a personal computer and so on.

The media playing device 14 includes a transmitting unit 141, a microcontroller 142, a memory 143, and a playing unit 144. The transmission unit 141, the microcontroller 142 and the memory 143 are electrically connected via a bus 145. The microcontroller 142 and the playing unit 144 are connected electrically via an output interface 146. In addition, when the social media sharing program 132 controls the media playing device 14 to play media, the microcontroller 142 controls the playing unit 144 through the output interface 146 to play audio or video.

The transmission unit 141 of the media playing device 14 controls the fifth communication link 20. The first communication link 16, the second communications link 17, the third communication link 18, the fourth communication link 19 and the fifth communication link 20 can be wired communication or wireless communication. The wireless communication satisfies the communication protocols, such as Bluetooth, Bluetooth Low Energy (BLE), Wireless Fidelity (Wi-Fi, Third Generation mobile communication (3G) or Fourth Generation mobile communications (4G) and so on. Wired communication satisfies the communication protocols, such as Open System Interconnection Reference Model (OSI), Transmission Control Protocol/Internet Protocol (TCP/IP), Point-to-Point (PPP) Protocol, PPP over Ethernet (PPPoE), Cable modem, Local Area Network (LAN), Wide Area Network (WAN), World Wide Web (WWW), NetWare, IPX/SPX, NetBEUI, Apple Talk, Asymmetric Digital Subscriber Line (ADSL), Public Switched Telephone Network (PSTN), Integrated Services Digital Network (ISDN) or Asynchronous Transfer Mode (ATM) and so on.

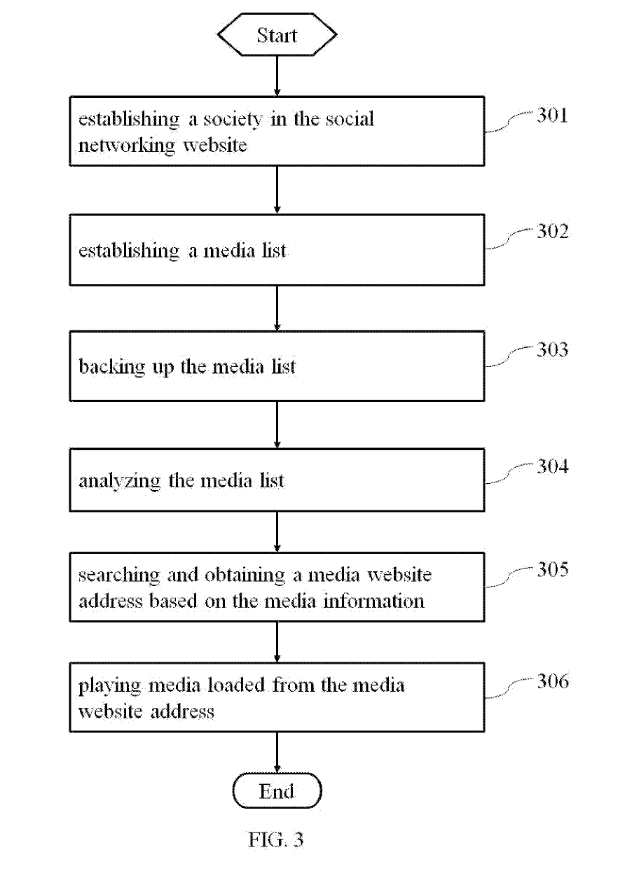

The social media sharing method is referred to FIG. 3, and FIG. 3 is a flowchart illustrating the social media sharing method in an embodiment of the present invention. This concept includes the operation manners in the aforementioned social media sharing system operation modes 1, 2 of, so please refer to FIG. 1 and FIG. 2 and the related components. The social media sharing method includes the following steps.

Step 301: establishing a society 111 in a social networking website 11. The users login the social networking website 11 and build the society 111 to recruit other users to become members therein.

Step 302: establishing a media list 1111, which can be co-edited, in the social networking website 11. The social networking website 11 includes a logged-in society 111, and the society 111 provides the media list 1111, which can be edited by each of the members in the society 111 to perfect the contents. In other words, after generating the media list 1111, each of the members in the society 111 can modify the media list 1111 and this is a common edit manner.

Step 303: backing up the media list 1111. The computing device 13 can download the media list 1111 to save it, or the media list 1111 can be downloaded to the computing device 13 and then uploaded to the cloud database 15 for the computing device 13 or the media playing device 14.

Step 304: analyzing the media list 1111 to acquire media information. In the social media sharing system 1, the media playing device 14 downloads the media list 1111 and the analyzing function 14311 is used to analyze the media list 1111 to acquire the media information (such as media name, media author, media owner or media link, etc.). In addition, in the social media sharing system 2, the analyzing function 1321 in the computing device 13 analyzes the media list 1111 to acquire the media information.

Step 305: searching and obtaining a media website address based on the media information. The querying function 14312 or 1322 is connected to the media resource platform 12 via the fourth communication link 19 or the sixth communication link 21. According to the form of the interface 122 for the media resource platform 12, the querying function 14312/1322 is set to the search strategy corresponding to the media resource. When searching is processed by the query interface 122, the media website address corresponding to the media information is acquired from the media website resource 121 via the data link 123.

Step 306: playing media loaded from the media website address. The social media sharing program 1431 of the media playing device 14 in the social media sharing system 1 implements the microcontroller 142 controls the playing unit 144 via the output interface 146 to play audio or video in accordance with the media website address. In addition, the social media sharing program 132 of the media playing device 14 in the social media sharing system 2 implements the microcontroller 142 of the media playing device 14 via the fifth communication link 20 controls the playing unit 144 to play audio or video via the output interface 146.

As described above, the present invention has been described with preferred embodiments thereof and it is understood that many changes and modifications to the described embodiments can be carried out without departing from the scope and the spirit of the invention that is intended to be limited only by the appended claims.

What is claimed is:

1. A social media sharing system, comprising:
a social networking website including a logged-in society, wherein the society provides a media list edited by a plurality of members in the society together;
a media resource platform including a media website resource;
a computing device with a media playing program connected to the social networking website by a first communication link and configured to download the media list from the social networking website;
a cloud database connected to the computing device by a second communication link and configured to receive the media list from the computing device; and
a media playing device including a transmission unit, a microcontroller, a memory, and a playing unit, communicated to the computing devices, the cloud database and the media resource platform, wherein the transmission unit, the microcontroller and the memory are electrically connected to each other by a bus, the microcontroller is electrically connected to the playing unit by an output interface, and the memory contains a social media sharing program;
wherein the media playing device acquires a media list from the cloud database, the social media sharing program analyzes the media list to get a media information and searches in the media resource platform according to the media information to obtain a media website address corresponding to the media information from the media website resource, and the microcontroller based on the media website address controls the playing unit to play media.

2. The social media sharing system according to claim 1, wherein the media playing device can play audio or video.

3. The social media sharing system according to claim 1, wherein the computing device is a mobile device or a computer.

4. The social media sharing system according to claim 1, wherein the first communication link and the second communication link can be wired communication or wireless communication.

5. The social media sharing system according to claim 4, wherein the wireless communication can be Bluetooth, Bluetooth Low Energy, Wi-Fi, Third Generation mobile communication or Fourth Generation mobile communication.

6. A social media sharing system, comprising:
a social networking website including a logged-in society, wherein the society provides a media list, edited by a plurality of members in the society together;
a media resource platform including a media website resource;
a computing device with a social media sharing program connected to the social networking website by a first communication link and configured to download the media list from the social networking website; and
a media playing device, communicated to the computing device;
wherein the social media sharing program analyzes the media list to get a media information and searches in the media resource platform according to the media information to obtain a media website address corresponding to the media information from the media website resource, and the social media sharing program based on the media website address controls the media playing device to play media.

7. The social media sharing system according to claim 6, wherein the media playing device further comprises a transmission unit, a memory, a playing unit, and a microcontroller electrically connected to the playing unit by an output interface, wherein the transmission unit, the microcontroller and the memory are electrically connected to each other by a bus.

8. The social media sharing system according to claim 6, wherein the media playing device can play audio or video.

9. The social media sharing system according to claim 6, wherein the first communication link and the second communication link can be wired communication or wireless communication.

10. The social media sharing system according to claim 6, wherein the wireless communication can be Bluetooth, Bluetooth Low Energy, Wi-Fi, Third Generation mobile communication or Fourth Generation mobile communication.

11. A social media sharing method implemented by a social media sharing system comprising a computing device, a social networking website, a media resource platform, a cloud database, and a media playing device, comprising steps of:
establishing a media list, which can be co-edited, through the social networking website;
analyzing the media list to obtain a media information through a social media sharing program;
searching and obtaining a media website address based on the media information through the social media sharing program; and
playing media loaded from the media website address through the media playing device.

12. The social media sharing method according to claim 11, wherein the step of establishing the media list, which can be co-edited, through the social networking website further comprises:
establishing a society in the social networking website, and a plurality of members in the society editing the media list together.

13. The social media sharing method according to claim 11, wherein the step after the step of establishing the media list, which can be co-edited, through the social networking website further comprises:
backing up the media list.

14. The social media sharing method according to claim 11, wherein the step after the step of establishing the media list, which can be co-edited, through the social networking website further comprises:
comparing the media list with a cloud database to get a latest version.

15. The social media sharing method according to claim 13, wherein the media list is backed up in a cloud database.

16. The social media sharing method according to claim 11, wherein the step of searching and obtaining the media website address based on the media information through the social media sharing program further comprises
utilizing media name, media author, media owner or media link in the media information to search.
